(19) United States
(12) Patent Application Publication
(10) Pub. No.: US 2011/0086942 A1
(43) Pub. Date: Apr. 14, 2011

(54) REINFORCED ELASTOMERS

(75) Inventors: Agathe Robisson, Cambridge, MA (US); Partha Ganguly, Woburn, MA (US)

(73) Assignee: SCHLUMBERGER TECHNOLOGY CORPORATION, Cambridge, MA (US)

(21) Appl. No.: 12/577,121

(22) Filed: Oct. 9, 2009

(51) Int. Cl. C09K 8/44

(52) U.S. Cl. 523/130

(57) ABSTRACT

An elastomeric composition for use in a borehole comprising a base polymer and a reinforcing reactive filler is disclosed. The elastomeric composition maintains flexibility before interaction and rigidity after interaction and therefore is suitable for use in downhole sealing systems.

### BACKGROUND OF THE INVENTION

1. Field of the Invention

This present invention relates to elastomers and more particularly to reinforced elastomers.

2. Background of the Invention

Applications which utilize rubber require fillers as an additive as most pure rubbers are weak mechanically. Fillers are widely used to enhance the performance related properties of rubber and other polymeric materials. Rubbers are usually reinforced with fillers such as carbon black or silica. These fillers are reinforcing due to interactions with the polymer and fillers but also, in the case of carbon blacks, due to their ability to create 3-D networks of fillers by percolation, which results from interactions between fillers themselves. Percolation is related to the interactive forces between these fillers e.g. Van des Walls and hydrogen bonds (Wang, “Effect of polymer-filler and filler-filler interactions on dynamic properties of filled vulcanizates, Rubber Chemistry and Technology, 1998, Vol. 71, 520-589). A strong interaction between a polymer and filler usually promotes a good dispersion of the fillers and also leads to good adsorption of rubber at the surface of the filler, which enhances the modulus of the rubber. A strong interaction between fillers enhances the modulus by creating a composite effect but tends to prevent good filler dispersion as fillers tend to form large aggregates as the polymer/mixing process is not always powerful enough to break the interaction between the fillers. A disadvantage of these strong interactions between fillers is that they are destroyed by strain above a few percent whereby the agglomerates break and the reinforcement is lost. The phenomena of stress softening of a filled rubber with strain known as “Payne effect” arises from filler-filler interaction. These strong interactions (both filler/polymer and filler/filler) are also weakened with temperature. For these reasons, at high temperatures and for strains above 5%, a limited reinforcement is achieved by fillers in rubber due to the weak filler/filler and filler/polymer interactions.

Rubbers are commercially used in many downhole tools such as annular plugs e.g. permanent packers, axial plugs or radial plugs. Other applications where rubbers can be utilized are valves, proppant, cement additives and different kinds of seals. A useful property of rubber components, in certain applications, is absorption of fluid which results in swelling of the material. For example, a plug containing swellable rubber will swell in situ as a result of contact with a fluid or gas, thereby filling the gap between the tubing and the casing or the openhole. Swelling can also be used as an actuator which is simpler than a complex motorized actuation system. The swelling can also be controlled in situ by different triggers e.g. pH, temperature, electrical field etc. However, there is an associated disadvantage because the material's stiffness decreases after swelling. This decrease in modulus can also lead to a decrease in sealing ability. Unfortunately, this problem cannot be overcome by designing a stiffer initial rubber because the swelling ability is related to the crosslinking density of the polymer, which is directly responsible for the rubber stiffness. Also, reinforcing filler such as carbon black and silica do not swell and therefore adding more of these to increase the initial modulus also results in a decrease of the swelling ability of the rubber compound. Consequently, increasing the initial stiffness of the rubber reduces the ability to swell and the ability to form a seal.

### SUMMARY OF THE INVENTION

The present invention proposes to reinforce rubber using a reactive filler that stiffens the rubber in-situ. The resulting rubber, after reaction, is characterized by an increased modulus. The present invention further provides an elastomeric composition useful to create an improved seal. Seals formed with the elastomeric composition are particularly suited for use in a wellbore environment.

In accordance with a first aspect, an elastomeric composition for use in a borehole comprises a base polymer; a reinforcing reactive filler including a matrix of discreet portions of a first material disposed in the base polymer; the elastomeric composition being responsive to exposure to borehole fluid to change from a first phase to a second phase, and wherein the discreet portions of the first material are characterized by weaker interactions between themselves and/or the base polymer before exposure to the borehole fluid than after exposure, and wherein the first phase is characterized by a first modulus and the second phase is characterized by a second modulus, and wherein the second modulus is greater than the first modulus.

In accordance with a second aspect, a downhole seal comprising a base polymer; a reinforcing reactive filler including a matrix of discreet portions of a first material disposed in the base polymer; wherein the downhole seal is deployed into a wellbore in a first phase, and wherein the downhole seal changes to a second phase upon exposure to borehole fluid, wherein the discreet portions of the first material are characterized by weaker interactions between themselves and/or the base polymer before exposure to the borehole fluid than after exposure, and wherein the first phase is characterized by a first modulus and the second phase is characterized by a second modulus, and wherein the second modulus is greater than the first modulus.

In accordance with a third aspect, a method for forming a downhole seal in a wellbore comprising, providing a base polymer and a reinforcing reactive filler including a matrix of discreet portions of a first material disposed in the base polymer; deploying the downhole seal into a wellbore in a first phase; exposing the downhole seal to borehole fluid causing the seal to change to a second phase upon exposure to the borehole fluid, and wherein the discreet portions of the first material are characterized by weaker interactions between themselves and/or the base polymer before exposure to the borehole fluid than after exposure, and wherein the first phase is characterized by a first modulus and the second phase is characterized by a second modulus, and wherein the second modulus is greater than the first modulus.

Further features and advantages of the invention will become more readily apparent from the following detailed description when taken in conjunction with the accompanying drawings.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic illustration showing a wellbore sealing system in accordance with one or more embodiments of the invention;

FIG. 2 is a flow chart illustrating one or more embodiments of the invention;

FIG. 3A is a schematic representation of an elastomer and a non-reactive filler in accordance with one or more embodiments of the invention;

FIG. 3B is a schematic representation of an elastomer and a reactive filler interaction in accordance with one or more embodiments of the invention;

FIG. 4 is a flow chart illustrating one or more embodiments of the invention.

FIG. 5 depicts a graph showing the change in mass of the hydrating elastomeric composite over time and also indicates progression of curing;

FIG. 6A and 6B depicts a graph showing the percentage mass and volume increase over curing time for different elastomeric composites;

FIG. 7 depicts a graph showing stress versus strain at various curing times for one or more embodiments of the invention;

FIG. 8 depicts a graph showing the modulus increase over time in water in accordance with one or more embodiments of the invention;

FIG. 9 depicts a graph showing the storage modulus at different temperatures for one or more embodiments of the invention;

FIG. 10 depicts a graph showing the effect of curing time in water on the storage modulus of one or more embodiments of the invention;

FIG. 11 depicts a graph showing the relationship between volume increase and modulus increase for one or more embodiments of the invention;

FIG. 12 depicts a graph showing the effects of time in oil on the mass of one or more embodiments of the invention;

FIG. 13 depicts a graph showing modulus increase for one or more embodiments of the invention;

FIG. 14 depicts a graph comparing the modulus for one or more embodiments of the invention.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice. Further, like reference numbers and designations in the various drawings indicate like elements.

Certain examples described herein provide significant advantages over existing materials including, but not limited to, improved structural properties and improved sealing of spaces for extraction of fuels.

In certain examples, the compositions disclosed herein are particularly suited for use in downhole tools and devices such as packers used in extraction of fuels through a wellbore. Packers are used to isolate fluid producing regions and facilitate the production of oil and gas.

The present invention generally relates to reinforcing rubber using a reactive filler e.g. cement that will create a much stiffer rubber composite. The resulting rubber would therefore have a strong percolated network of fillers but also show very strong interactions between the filler and polymers. This is accomplished, in part, by having weak interactions while mixing the elastomeric composition thus facilitating dispersion of the fillers. Once the reaction (e.g. hydration of cement) has occurred strong interactions between the fillers and between fillers and polymer causes the filler network to become mechanically strong, resulting in a material that is resistant to disruption by chemicals, temperature and mechanical loading.

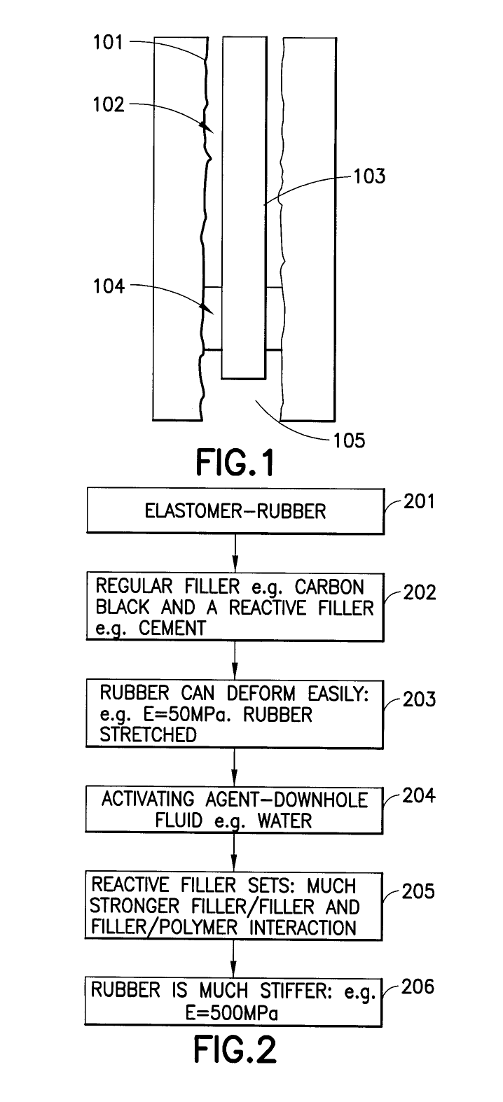

Some aspects of the invention pertain to oilfield systems and, in some cases, to sealing at least a portion of a subsystem or component of a unit operation in an oilfield. One skilled in the art will recognize that the present invention has numerous non-oilfield applications. Thus, although some aspects of the present invention are directed to sealing a wellbore, the various components and techniques of the invention are not limited as such and may be implemented in other facilities. As exemplarily illustrated in the cross-sectional schematic diagram in FIG. 1, the sealing system of the invention can provide at least one seal (104) disposed in a space (102) typically defined between a wall (101) of a wellbore (105) and a downhole tubing assembly (103). In accordance with the present invention, the downhole tubing assembly (103) may include, but is not limited to, a cased hole, a production tubing setting, or an open hole. One skilled in the art will recognize that numerous other downhole tubing assemblies (103) are directly applicable to the present invention. Seal (104) typically serves to fluidly isolate a first or upper section from a second or lower section of the wellbore (105) so that formation fluid (not shown) in the wellbore is directed into the downhole tubing assembly (103).

The sealing systems and techniques can utilize one or more reinforced composite materials. The reinforced composite materials can be disposed or placed in service by utilizing supporting components that can be deployed to position the one or more reinforced composite materials. Further components or subsystems of the sealing systems of the invention can include actuating mechanisms and/or securing systems that ensures deployment and positioning of the one or more sealing systems of the invention.

Reinforced composite materials used as a seal (104) in wellbores must be both flexible to ensure easy placement in the wellbore but also rigid to ensure an effective seal. The reinforced composite materials of the present invention maintain flexibility before interaction and rigidity after interaction and therefore are suitable for use in downhole sealing systems.

Reinforced composite materials, more specifically rubber/cement composites are suitable for use as sealants in oil wells, where it would be efficient to place a compact, flexible material that will expand and then stiffen to fit the space. Reinforced composite materials more specifically rubber/cement composites are suitable also for use as wellbore plugs e.g. for plugging perforations. The composite materials for these tools needs to be stretchable but when in contact with the borehole it needs to stiffen and remain in place. Another application for the above embodiment would be to use this material in different types of packers e.g. mechanical packers, swellable packers, expandable packers and o-rings. A further application for the embodiments of the invention would be to plug off fluid flow in the casing below the plug e.g. to seal off non-productive zones.

The mechanical properties of rubber composites can change considerably depending on both their environment and the materials they are compounded with. Rubbers may swell on introduction to oil or water, and its filler, if reactive, may experience some chemical change that affects the properties of rubber. To change the properties of a rubber, fillers of different kinds may be added to rubber.

An embodiment of the present invention comprising a composite of rubber with regular reinforcing fillers e.g. Carbon Black or Silica and reactive fillers like cement whereby fillers create strong bonds with each other and/or with the polymer matrix and therefore a strong reinforcing composite is created. The composite sample when in contact with a fluid creates a strong reinforcement. Cement is a reactive filler and undergoes a chemical reaction when an activating agent e.g. water diffuses into the composite and the dry cement mix hydrates and strengthens the rubber compound. When the cement is compounded with rubber, the dry composite acts like a rubber with a nonreactive filler e.g. carbon black or silica filler but with the addition of an activating agent e.g. water the reactive filler stiffens and swells creating a stiff elastomeric composite.

Once the activating agent e.g. water diffuses into the composite the reactive filler hydrates. The resulting network reinforces the composite and therefore much larger stresses are necessary to deform to the breaking point.

An embodiment of the present invention comprises a composite of an oil-swellable elastomeric compounded with a reactive filler. When the composite material is disposed in the wellbore environment or at least exposed to at least one activating fluid e.g. at least one component of formation fluid typically present in the wellbore the composite material will significantly increase volumetrically. When the composite material is disposed in the wellbore or at least exposed to at least one activating fluid e.g. at least one component of formation fluid typically present in the wellbore, the reactive filler will react with the activating fluid and the resulting material is a reinforced composite. When the composite material is disposed in the wellbore environment or at least exposed to at least one activating fluid e.g. at least one component of formation fluid typically present in the wellbore the composite material will increase in stiffness.

Embodiment of the present invention, which increases in both volume and stiffness can be utilized for the seal (104) of the present invention. The seal (104) can utilize embodiments of the present invention whereby the elastomeric component is first stretched and then exposed to fluid for a long period of time whereby the reactive filler e.g. cement will set in the stretched sample creating a rigid structure.

FIG. 2 depicts an embodiment of the present invention whereby an elastomeric compound (201) e.g. a rubber is compounded with a non-reactive filler and a reactive filler (202) e.g. cement. The filler of the present embodiment is a cement powder which is added in a sufficient quantity to create a sufficient reinforcement in the rubber matrix when it sets. The initial compound has a low modulus e.g. 50 MPa and therefore can deform easily (203). This is a useful mechanical property as it allows the rubber composite to stretch therefore the composite of rubber can stretch to fit a desired sealant space. When the rubber compound is exposed to a fluid e.g. an activating agent (204) the activating agent activates the reactive filler (202) and the reactive filler (202) sets to form an elastomeric compound (205) which has much stronger interaction between the elastomeric network. The reactive filler (202) reacts with the activating agent (203) e.g. water and hydrates and sets. The resulting elastomeric compound (206) has a much higher modulus e.g. 500 MPa and is therefore much stiffer and forms a much stronger reinforced seal (104).

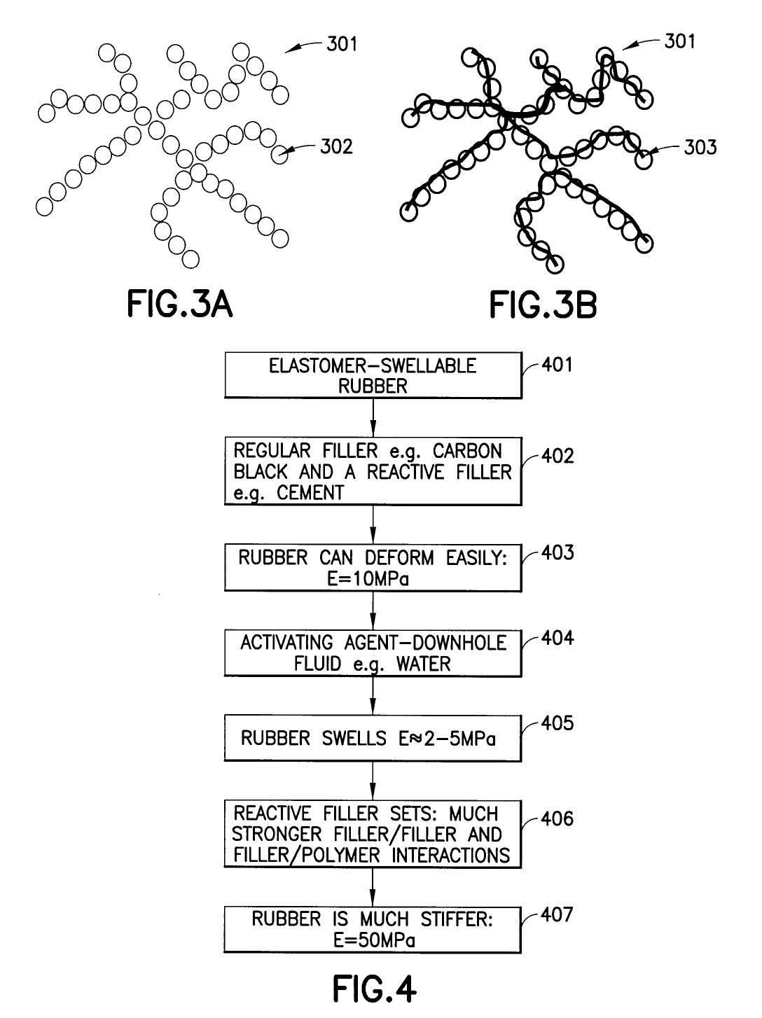

FIG. 3A illustrates an elastomer (301) with a non-reactive reinforcing filler (302) e.g. carbon black, silica etc. The basic parameters of the filler particles responsible for reinforcement are (1) particle size or specific surface area (2) structure (irregularity) of the filler which has an essential role in restricting motion of polymer strains under strain (3) surface activity. Carbon black and untreated silica are nonreactive fillers, which form a network within the rubber matrix and are held together by weak (Van der Waals, hydrogen) forces. The intermolecular forces are weak therefore a small amount of strain or swelling will pull apart the filler network removing all of its reinforcing properties.

FIG. 3B illustrates an embodiment of the present invention whereby an elastomeric compound e.g. rubber (301) is reinforced with a reactive filler (303). The elastomeric compound (301) reacts with an activating agent e.g. water and this hydrates the reactive filler creating either a stiff 3D network with covalent inter-particles bonds or a strong interaction between filler and rubber.

FIG. 4 illustrates a further embodiment of the present invention whereby an elastomeric compound e.g. swellable rubber (401) is reinforced with both a non-reactive and reactive filler. Swellable rubbers both oil and water swellable rubbers lose stiffness upon swelling which can be avoided by using reactive fillers such as cement which are added to the polymer. The composite of rubber which includes a swellable rubber (401) swells and once swollen the rubber can rigidify because of the reactive filler setting within the rubber. One of the difficulties encountered in the present embodiment was to control the kinetics of the filler (cement) setting compared to the matrix swelling. Retardants for cement can be useful and are utilized. The swellable rubber (401) is compounded with both a reactive and a non-reactive filler (402). Initial modulus of the material is low and therefore the material can be stretched to a large strain like any other rubber but after exposure to an activating fluid the reactive filler sets inside the rubber and creates a composite effect that strongly reinforces the material. The initial composite can deform easily and has a modulus of approximately 10 MPa. When the elastomeric compound e.g. swellable rubber (402) is exposed to an activating agent (404), which can be oil or water the swellable rubber (402) will swell. Both oil and swellable rubber (402) lose some of their stiffness upon swelling e.g. modulus 2.5 MPa. The activating agent (404) will also cause the reactive filler to react creating a composite much stiffer rubber with a modulus of 50 MPa. This increase in both volume and stiffness creates a composite structure which is ideal for a downhole sealant (104) in oil wells as the initial flexibility and compact size coupled with their ability to eventually become stiff and increase in volume make them both easy to deploy and effective as sealants in a downhole environment e.g. wellbore. In a first stage the rubber is in a non-swelling phase with the filler homogenously distributed with little interaction with the elastomeric matrix. In a second stage the rubber swells and the reactive filler will react with the elastomeric matrix creating strong bonds and a stiff network of filler inside the swollen polymer network. The decrease in stiffness in rubber can be compensated and surpassed by the creation of the network of reactive filler. An increase of a factor 10 or 20 in a modulus can be achieved.

As the reactive filler is cement the stiffening will be irreversible. Once the reactive filler, in this non-limiting example cement, has reacted with the activating agent no further swelling or any important deformation of the polymer network can occur i.e. once the stiff network has set the polymer cannot deform to large elongation anymore. Other non-limiting examples of reactive fillers are epoxies that cure with water or epoxies that cure with heat.

### EXAMPLE 1

The first example of elastomeric composites of embodiments of the present invention will be described with reference to a non-swellable rubber composition. The swell-resistant rubber HNBR (Hydrogenated nitrile rubber) was compounded with either D169 small-particle cement or D909 class H Cement. The rubber/cement samples have been manufactured using conventional rubber compounding techniques e.g. twin roll mill or internal mixer with high shear being used to disperse fillers and additives. Once compounded the samples look like a regular rubber sample. HNBR is suitable for use at high temperature as it resists both absorption of water and oil. The composition of the swell-resistant rubber HNBR compounded with D169 or with D909 Class H cement is shown below in Table 1 and Table 2. The basic rubber composition formulation is presented in Table 1 or Table 2 and the ingredients are expressed in terms of mass, namely parts by weight (phr) unless otherwise indicated. The HNBR is relatively inert to oil. The percentages of HNBR by volume are 51% HNBR, 39% cement and 10% carbon black.

TABLE I
Component proportions for Elastomeric
Compositions with HNBR/D169 Composition

| | mass | In mass | Volume |
|---|---|---|---|
| Small Particle Cement D-169 | (phr) | (%) | (%) |
| HNBR(Therban C 43% CAN) | 100 | 24.45 | 51.06 |
| Portland Cement D169 w/d 95 | 250 | 61.12 | 39.31 |
| <9.5 μm | | | |
| N330 black | 35 | 8.56 | 9.63 |
| Additives | 24 | | |

TABLE 2
Component proportions for Elastomeric Compositions
with HNBR/D909 Composition

| | mass | mass | volume |
|---|---|---|---|
| Regular Cement D909 | (phr) | (%) | (%) |
| HNBR(Therban C 43% CAN) | 100 | 24.75 | 51.06 |
| Portland Cement D909 w/class H | 250 | 61.88 | 39.31 |
| N330 black | 35 | 8.66 | 9.63 |
| Additives | 19 | | |

All materials were blended and the swell-resistant HNBR cement composite samples were each massed and samples were then submerged in water for 48 hours at 80° C. At intervals of different hours a set of samples were removed from the water bath, massed and then put back into an oven in a dry container to evaporate off all non-bound water. The composites were dried for 72 hours after curing to eliminate all non-bound water. After drying, the mass of the samples was measured again. From the resulting composites the hydration kinetics and setting kinetics could be obtained. This was accomplished by measuring mass change, small strain elastic modulus and young's modulus.

FIG. 5 depicts the change in mass of the hydrating rubber/cement composites over time and indicates the progress of curing. The water uptake of cement was rapid for the first few hours but slowed as the amount of uncured cement decreased. In addition, the composite with D169 cement hydrated more completely absorbing twice the water over the course of the curing period. The smaller particle size is advantageous for water to reach and react with all of the reactive filler e.g. cement.

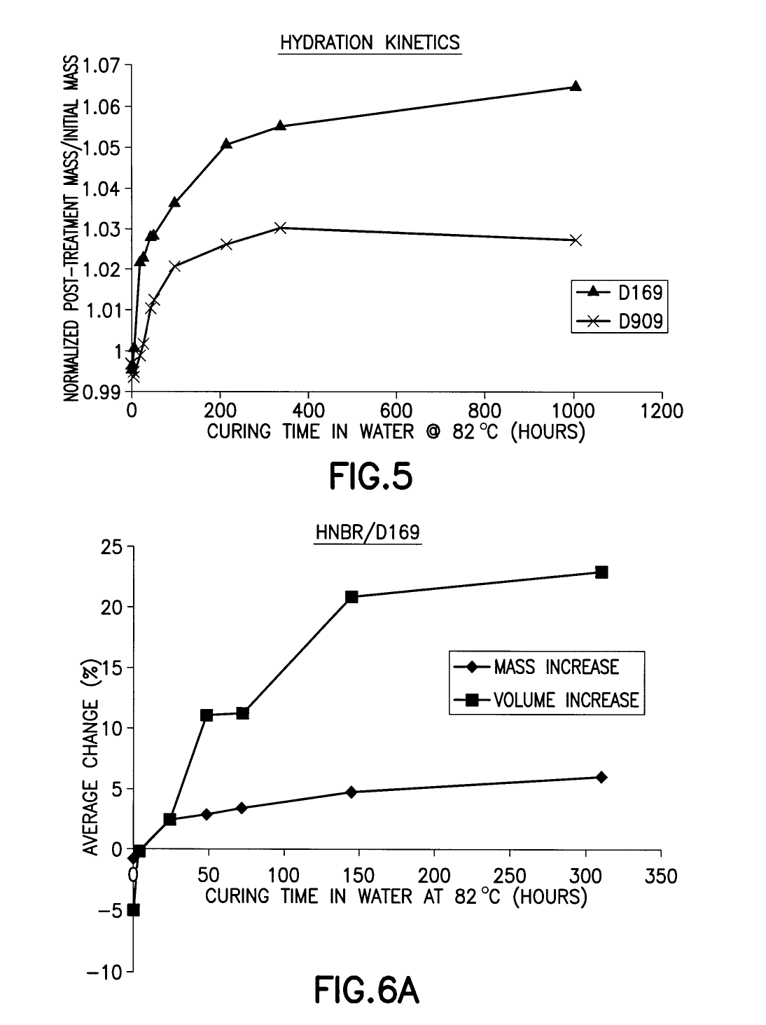

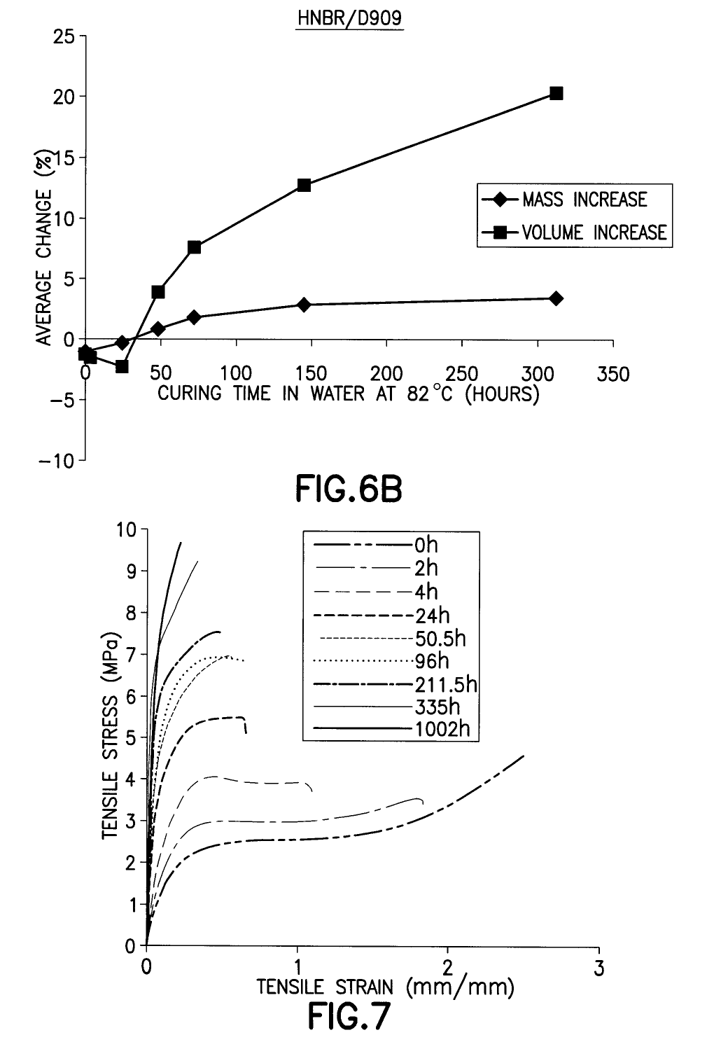

FIGS. 6A and 6B depict the percentage mass and volume increase over curing time for both HNBR D169 composite and HNBR D909 composite. The composites gain up to 6% in mass over the curing process. The volume increases by as much as 25% in 300 hours. The volume increase is important based on the mass uptake of about 6% overall and the extra mass came from the absorption of water therefore the volume increase would be expected to be on the same order of magnitude. The increase in volume by the rubber/cement composites is useful as a downhole sealant. Tensile testing of the composites indicates much more compliance than cement but also indicated much greater strength and stiffness.

FIG. 7 depicts a graph of stress versus strain uniaxial tensile curves for HNBR/D169 at various curing times after each sample was dried for 48 hours. At 0 hours of exposure the composite behaves like a rubber. When exposure time increases i.e. cement is reacting in the elastomeric composite the strength of the composite increases.

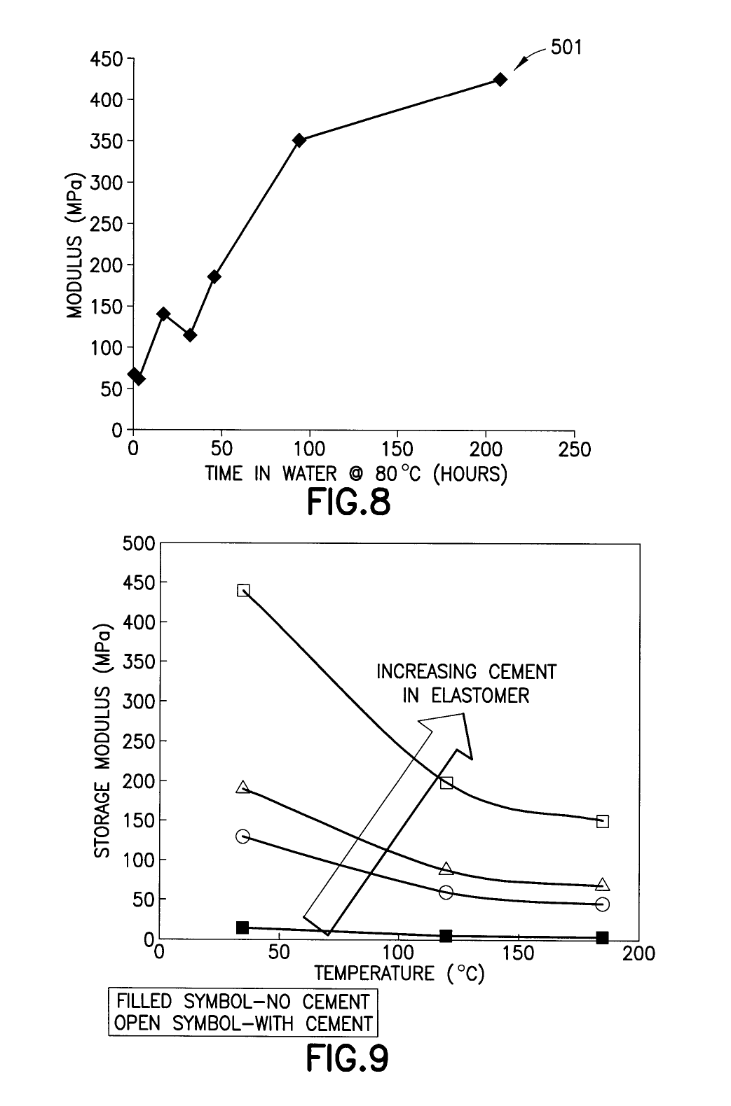

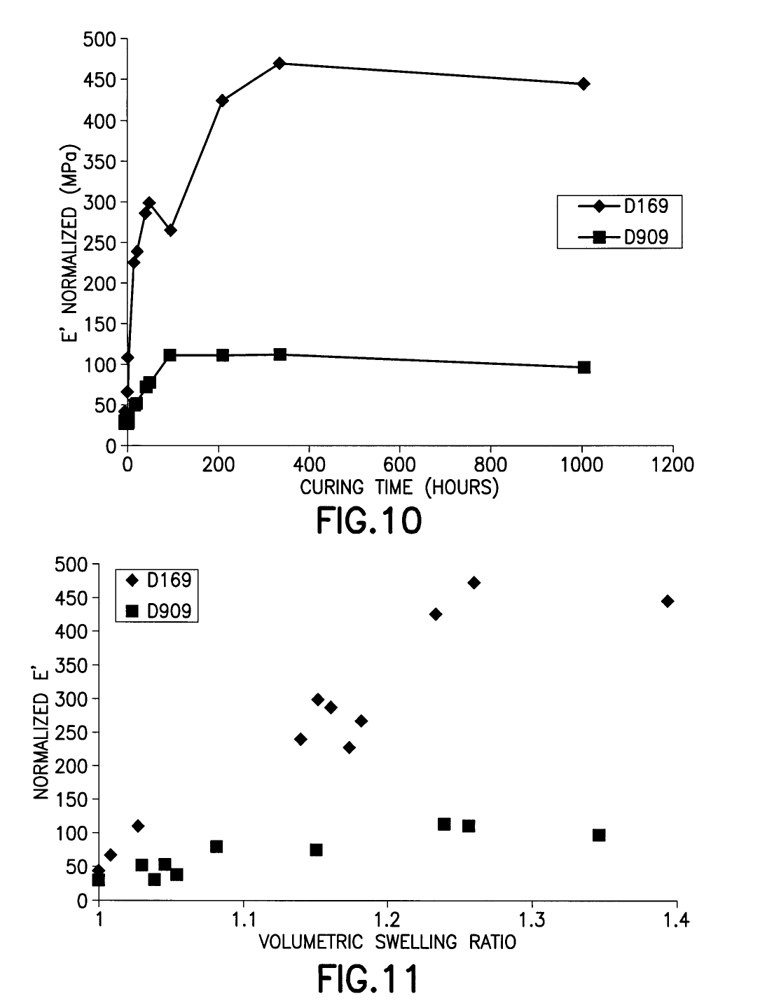

FIG. 8 depicts the modulus increase over time in water. Once the reactive filler in this case cement is hydrated and set the material is stiff (501). The modulus increase is by a factor of 10 creating a rigid composite. FIG. 9 shows that prior to the cement setting the material is flexible but once the cement is hydrated and set the material is stiff. FIG. 10 depicts the effect of curing time on the storage modulus for HNBR/cement composites. Curing causes the modulus of both composites to increase but the D169 composite's cured modulus is more than four times larger than that of the D909 composite. Similar to hydration the change in modulus is initially very rapid but slows with increasing curing time as the non-hydrated cement decreases both in quantity and in ease of saturation. Particle size influences the initial difference in modulus as the modulus of the D169 composite before curing is about four times of that of the uncured D909 composite. Small diameter filler particles provide greater reinforcement that larger ones as they have more available surface area per volume to interact with the rubber matrix. Their smaller size may also increase their ability to form a percolated 3-D network of stiff material.

FIG. 11 depicts the relationship between volume increase and modulus increase for HNBR/cement composites. The correlation of normalized storage modulus and volumetric swelling ratio (VSR) shows that the samples grew up to 25% of their original volume while the storage modulus increases by nearly 10×. This shows that non-swelling HNBR/cement increases in both volume and rigidity and therefore is useful as reinforced compositions for downhole sealants.

### EXAMPLE 2

The second example of elastomeric composites of embodiments of the present invention will be described with reference to a swellable rubber composition. The swellable rubber EPDM (ethylene propylene diene Monomer (M-class) rubber) was compounded with D909 class H Cement. The rubber can also be an oil swellable material such as SBR, EPDM, neoprene, NR, NBR, BR, or any blend of these. Water swellable materials can be polyacrylate, polyacrilimide, zwitterionic polymer, etc. Cement retardants e.g. Borax and EDTMP can be added to the polymer mixture as a cement retardant to control the kinetics of the two reactions. Polymeric swelling should occur before reaction of the filler.

The composition of the swellable rubber EPDM compounded with D909 or with EPDM with no cement is shown below in Table 3 and Table 4. The basic rubber composition formulation is presented in Table 3 or Table 4 and the ingredients are expressed in terms of mass, namely parts by weight (phr) unless otherwise indicated. The percentages of EPDM by mass are 24% HNBR, 60% cement and 8% carbon black with 8% other ingredients. The concentrations by volume are 54% EPDM, 37% cement and 9% carbon black.

TABLE 3
Component proportions for Elastomeric
Compositions with EPDM Composite

| Small Particle | mass | In mass | Volume |
|---|---|---|---|
| Cement D-169 | (phr) | (%) | (%) |
| EPDM Nordell IP 4640 | 100 | 61.16 | 85.67 |
| Portland Cement D909 | 0 | 0 | 0 |
| N330 black | 35 | 21.41 | 14.33 |
| Additives | 28.5 | | |

TABLE 4
Component proportions for Elastomeric Compositions
with EPDM/Cement Composite

| Small Particle | mass | In mass | Volume |
|---|---|---|---|
| Cement D-169 | (phr) | (%) | (%) |
| EPDM Nordell IP 4640 | 100 | 24.18 | 54.06 |
| Portland Cement D909 | 250 | 60.46 | 36.90 |
| N330 black | 35 | 8.46 | 9.04 |
| Additives | 28.5 | 6.9 | |

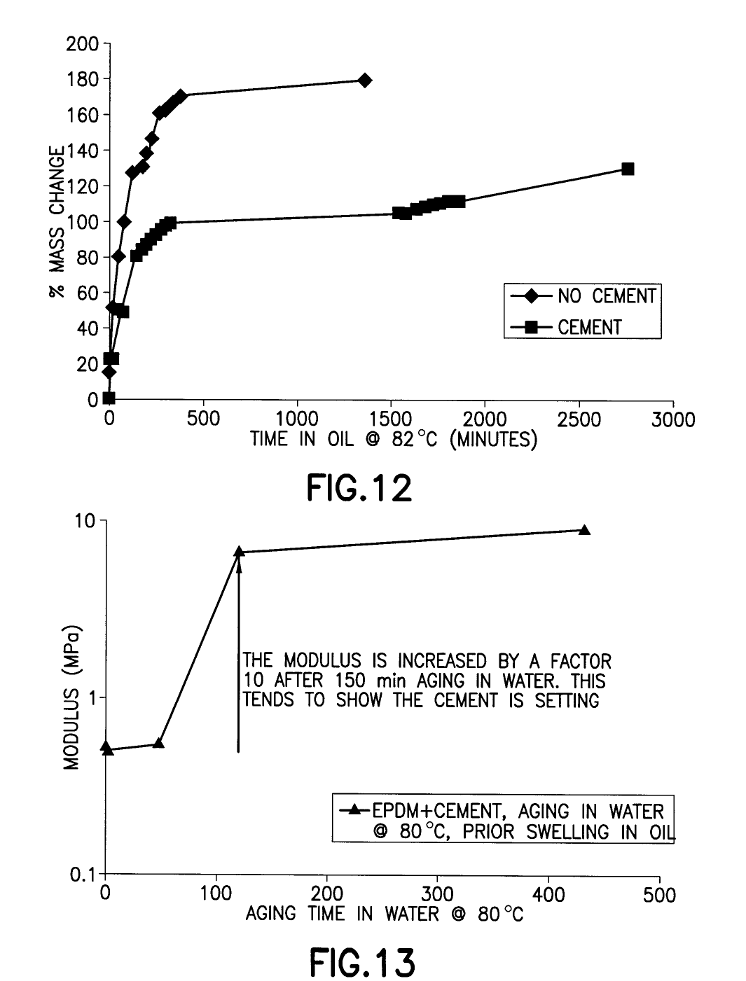

FIG. 12 depicts the effects of time in oil on the mass of a swellable rubber e.g. EPDM in composites. The initial mass of the rubber present in each compound was calculated and based on that number the degree of swelling of the rubber alone was determined The EPDM in the cement-containing composite swelled to a much greater degree than the EPDM in the non-cement composite. An increase in swelling is important for use of these elastomeric composites as a sealant.

FIG. 13 depicts a modulus increase with water aging in an EPDM/Cement composite which is aged in water at 80° C. and the composite has also been swelled in oil. The modulus increases by a factor of 10 after 150 min aging in water after the cement reacts and sets.

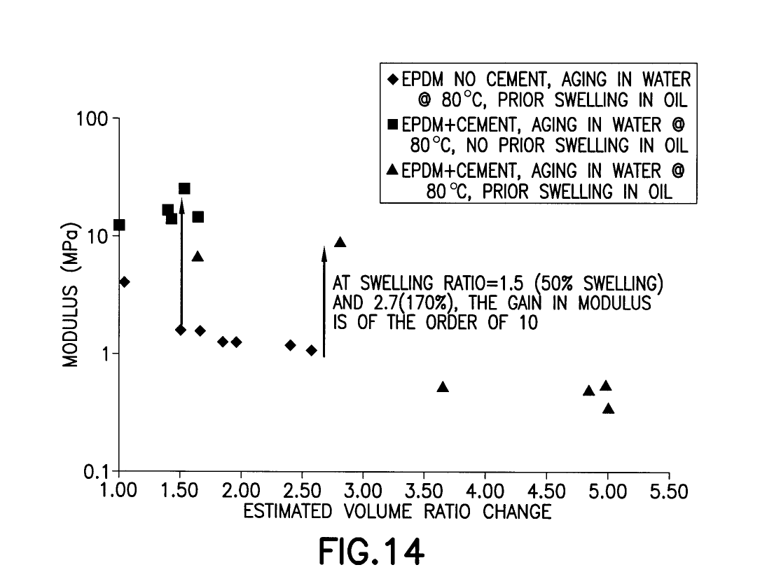

FIG. 14 compares the modulus of a composite with EPDM and cement at equivalent swelling ratio. At a swelling ratio of 1.5 (50%) swelling and a swelling ratio of 2.7 (170%) the gain in modulus is of the order of 10. In other words, when cement is present in EPDM and water is available, the EPDM/cement composite both swells and stiffens. On the contrary, when no cement is added to the EPDM compound, modulus decreases with swelling ratio.

Whereas many alterations and modifications of the present invention will no doubt become apparent to a person of ordinary skill in the art after having read the foregoing description, it is to be understood that the particular embodiments shown and described by way of illustration are in no way intended to be considered limiting. Further, the invention has been described with reference to particular preferred embodiments, but variations within the spirit and scope of the invention will occur to those skilled in the art. It is noted that the foregoing examples have been provided merely for the purpose of explanation and are in no way to be construed as limiting of the present invention. While the present invention has been described with reference to exemplary embodiments, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. An elastomeric composition for use in a borehole comprising:
a base polymer;
a reinforcing reactive filler including a matrix of discreet portions of a first material disposed in the base polymer;
the elastomeric composition being responsive to exposure to borehole fluid to change from a first phase to a second phase, and
wherein the discreet portions of the first material are characterized by weaker interactions between themselves and/or the base polymer before exposure to the borehole fluid than after exposure, and wherein the first phase is characterized by a first modulus and the second phase is characterized by a second modulus, and wherein the second modulus is greater than the first modulus.

2. The elastomeric composition of claim 1 further comprising a reinforcing non-reactive filler.

3. The elastomeric composition of claim 1 wherein the borehole fluid diffuses and reacts with the reinforcing reactive filler.

4. The elastomeric composition of claim 1 wherein the base polymer includes a non-swellable rubber.

5. The elastomeric composition of claim 1 wherein the base polymer includes a swellable rubber.

6. The elastomeric composition of claim 1 having improved mechanical properties.

7. The elastomeric composition of claim 1 wherein the reinforcing reactive filler is a cement powder or an epoxy.

8. The elastomeric composition of claim 7 wherein the cement volume is 40%.

9. The elastomeric composition of claim 1 wherein the reinforcing reactive filler comprises small particles.

10. The elastomeric composition of claim 9 wherein the small particles are dispersed homogenously in said first phase.

11. The elastomeric composition of claim 1 wherein a volume of the reinforcing reactive filler increases on exposure to the borehole fluid.

12. The elastomeric composition of claim 1 wherein a volume of the base polymer increases on exposure to the borehole fluid.

13. The elastomeric composition of claim 1 wherein the elastomeric composition swells to about 30% of its original volume in-situ.

14. The elastomeric composition of claim 1 wherein the first modulus is about 10 MPa.

15. The elastomeric composition of claim 1 wherein the second modulus is about 100 MPa.

16. The elastomeric composition of claim 1 wherein conversion from the first to second phase is irreversible.

17. A downhole seal comprising:
a base polymer;
a reinforcing reactive filler including a matrix of discreet portions of a first material disposed in the base polymer; and
wherein the downhole seal is deployed into a wellbore in a first phase, and wherein the downhole seal changes to a second phase upon exposure to borehole fluid, wherein the discreet portions of the first material are characterized by weaker interaction between themselves and/or the base polymer before exposure to the borehole fluid than after exposure, and wherein the first phase is characterized by a first modulus and the second phase is characterized by a second modulus, and wherein the second modulus is greater than the first modulus.

18. The downhole seal of claim 17 wherein the first phase is a compliant phase and the second phase is a rigid phase.

19. The downhole seal of claim 17 wherein the second phase is settable.

20. The downhole seal of claim 17 wherein the downhole seal is a permanent and irreversible seal.

21. The downhole seal of claim 17 wherein the downhole seal forms a stiff network in-situ.

22. The downhole seal of claim 17 wherein the downhole seal is first stretched and then exposed to fluid for a long period of time.

23. The downhole seal of claim 17 wherein the downhole seal is a packer, o-ring or a bridge plug.

24. A method for forming a downhole seal in a wellbore comprising:
providing a base polymer and a reinforcing reactive filler including a matrix of discreet portions of a first material disposed in the base polymer;
deploying the downhole seal into a wellbore in a first phase;
exposing the downhole seal to borehole fluid causing the seal to change to a second phase upon exposure to the borehole fluid, and
wherein the discreet portions of the first material are characterized by weaker interactions between themselves and/or the base polymer before exposure to the borehole fluid than after exposure, and wherein the first phase is characterized by a first modulus and the second phase is characterized by a second modulus, and wherein the second modulus is greater than the first modulus.

25. The method of claim 24 wherein the deploying step comprises deploying the seal in a first compliant phase and the exposing step causes a second phase which is a rigid phase.

26. The method of claim 24 wherein the second phase is settable.
